(19) United States
(12) Patent Application Publication
(10) Pub. No.: US 2007/0115513 A1
(43) Pub. Date: May 24, 2007

(54) Printing file processing method of image forming apparatus and image forming apparatus

(75) Inventors: Ho-sung Han, Suwon-si (KR); Seung-bae Yang, Gwacheon-si (KR)

Correspondence Address: STEIN, MCEWEN & BUI, LLP, 1400 EYE STREET, NW, SUITE 300, WASHINGTON, DC, 20005, US

(73) Assignee: Samsung Electronic Co., Ltd., Suwon-si (KR)

(21) Appl. No.: 11/593,539

(22) Filed: Nov. 7, 2006

(30) Foreign Application Priority Data
Nov. 21, 2005 (KR) 2005-111266

(51) Int. Cl. H04N 1/00

(52) U.S. Cl. 358/403; 358/1.15

(57) ABSTRACT

A printing file processing method of an image forming apparatus which prints images on media includes receiving printing files, displaying an alignment menu comprising a plurality of alignment standards to align the received printing files, selecting an alignment standard in the displayed alignment menu, aligning the received printing files on the basis of the selected alignment standard, and displaying at the image forming apparatus the received printing files in the aligned order. Accordingly, a user can search and select a desired printing file conveniently using a printing file processing method of an image forming apparatus.

### CROSS-REFERENCE TO RELATED APPLICATION

This application claims the benefit of Korean Application No. 2005-111266, filed on Nov. 21, 2005 in the Korean Intellectual Property Office, the disclosure of which is incorporated herein by reference.

### BACKGROUND OF THE INVENTION

1. Field of the Invention

Aspects of the present invention relate to an image forming apparatus and a printing file processing method therefor.

2. Description of the Related Art

In general, an image forming apparatus prints image information processed by an image processing apparatus (such as a host computer) on a printing paper. Such an image forming apparatus may be classified as an electrophotographic type, an inkjet type, and a thermal transfer type. The electrophotographic type image forming apparatus forms an image by spreading a developer on an electrostatic latent image formed on a photosensitive body by a potential difference, and transferring the developed image onto a printing paper. The inkjet type image forming apparatus forms an image by jetting an ink through a plurality of ink nozzles onto a printing paper. The thermal transfer type image forming apparatus forms an image by adhering an ink ribbon onto a printing paper, and selectively heating the ink ribbon to transfer ink of the ink ribbon onto the printing paper.

As image forming apparatuses become highly functional and as memory-related technologies develop, the image forming apparatus can directly receive a large quantity of printing files to be printed without the use of the image processing apparatus, and can selectively print a desired printing file from among the large quantity of received printing files through a user interface part installed directly on the image forming apparatus.

FIG. 1 is a flow diagram illustrating a related art printing file processing method of an image forming apparatus. As shown, when the printing file is received (operation S110), the printing file is aligned in the order that the printing file was received to be displayed on a user interface part (operation S120). Then, a user selects a desired printing file through the user interface part (operation S130) to print the selected printing file on a printing paper (operation S140).

However, in the related art printing file processing method of the image forming apparatus, the printing file is displayed in the user interface part only in the received order. Accordingly, it may be inconvenient for a user to search and select a desired printing file for printing. Particularly, when the image forming apparatus receives a large quantity of printing files, it may take the user a great deal of time and effort to search and select the desired printing file.

### SUMMARY OF THE INVENTION

Accordingly, aspects of the present invention include a printing file processing method of an image forming apparatus in which a user can search and select a desired printing file conveniently.

According to aspects of the present invention, a printing file processing method of an image forming apparatus which prints images on media includes: receiving printing files; displaying an alignment menu comprising a plurality of alignment standards to align the printing files; selecting an alignment standard in the alignment menu; aligning the printing files on the basis of the selected alignment standard; and displaying the printing files in the aligned order.

According to an aspect of the present invention, the alignment standard includes a printing time order and/or a printing frequency order.

According to an aspect of the present invention, the alignment standard includes a file name order, a file size order, a file sort order, a file generated time order, a file maker order, a file receiving time order of the printing files, or any combinations thereof.

According to an aspect of the present invention, at the selecting operation the plurality of alignment standards can be orderly or serially selected, and at the aligning operation the printing files according to the alignment standard are first aligned, and then the printing files are aligned within the first aligned order according to the next selected alignment standard.

According to an aspect of the present invention, at the aligning operation, information corresponding to the selected alignment standard is searched in the printing files and the printing files are aligned on the basis of the searched result.

According to an aspect of the present invention, a printing file processing method of an image forming apparatus further includes: selecting at least one of the displayed printing files after the file displaying operation, and printing the selected printing file.

According to an aspect of the present invention, a printing file processing method of an image forming apparatus further includes: recording a printing time information and/or a printing frequency information on the printed file after printing the selected printing file.

According to an aspect of the present invention, a printing file processing method of an image forming apparatus further includes: printing the printing files in the aligned order after the file displaying operation, and recording a printing time information and/or a printing frequency information on the printed files.

According to aspects of the present invention, an image forming apparatus includes: a user interface part for selectively inputting and displaying; a data receiving part to receive printing files; a standard setting part comprising an alignment menu to align the printing files and having a plurality of alignment standards capable of being selectively inputted through the user interface part; a controller to align the printing files on the basis of the alignment standard selected by the standard setting part, and to display the printing files on the user interface part in the aligned order, and an image forming includes an image forming part printing the printing files, wherein the controller enables the image forming part to print the printing files selectively inputted through the user interface part.

According to an aspect of the present invention, the alignment standard includes a printing time order and/or a printing frequency order.

According to an aspect of the present invention, the alignment standard includes a file name order, a file size order, a file sort order, a file generated time order, a file maker, a file receiving time of the printing files, or any combinations thereof.

According to an aspect of the present invention, the standard setting part can orderly select a plurality of alignment standards through the user interface part, the controller aligns the printing files according to the first selected alignment standard, and then aligns the printing files within the first aligned order according to the next selected alignment standard.

According to an aspect of the present invention, the controller searches information corresponding to the selected alignment standard in the printing files to align the printing files on the basis of the searched result.

According to an aspect of the present invention, an image forming apparatus further includes a record part recording at least one of a printing time information and the printing frequency information on the printing files printed by the image forming part.

According to aspects of the present invention, a file processing method of an image forming apparatus, the image forming apparatus having received a plurality of files and containing one or more ordering instructions selectable by a user to order the plurality of the files according to desired characteristics of the files, the method includes: ordering a plurality of the files according to a first ordering instruction to obtain a first level grouping of the plurality of the files, wherein the first level grouping contains one or more groupings of the plurality of the files; and ordering the one or more groupings of the first level grouping according to a second ordering instruction to obtain one or more corresponding second level groupings of each of the one or more groupings of the first level grouping.

According to aspects of the present invention, an image forming apparatus includes: a user interface part; a data receiving part to receive a plurality of files; a standard setting part containing one or more ordering instructions selectable by a user to order the plurality of the files according to desired characteristics of the files; a controller to order a plurality of the files according to a first ordering instruction to obtain a first level grouping of the plurality of the files, wherein the first level grouping contains one or more groupings of the plurality of the files, and to order the one or more groupings of the first level grouping according to a second ordering instruction to obtain one or more corresponding second level groupings of each of the one or more groupings of the first level grouping; and an image forming part to print the ordered files, wherein the controller enables the image forming part to print the ordered files.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the aspects, taken in conjunction with the accompanying drawings of which:

FIG. 1 is a flow diagram illustrating a printing file processing method of a related art image forming apparatus.

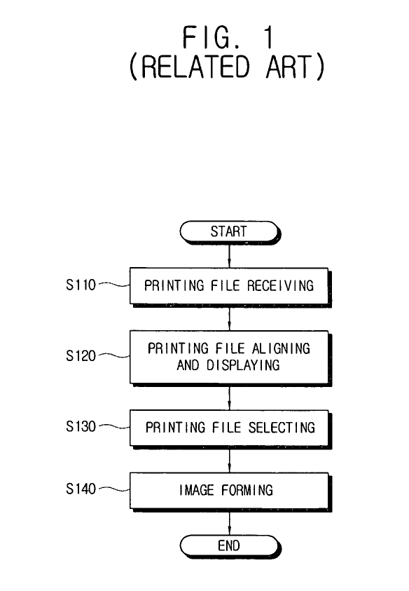

FIG. 2 is a flow diagram illustrating a printing file processing method of an image forming apparatus according to an aspect of the present invention.

FIG. 3 is a block diagram illustrating an image forming apparatus according to an aspect of the present invention.

FIG. 4 is a schematic view illustrating an alignment menu of FIG. 3.

### DETAILED DESCRIPTION OF THE EMBODIMENTS

Reference will now be made in detail to the aspects of the present invention, examples of which are illustrated in the accompanying drawings, wherein like reference numerals refer to like elements throughout. The aspects are described below so as to explain the present invention by referring to the figures.

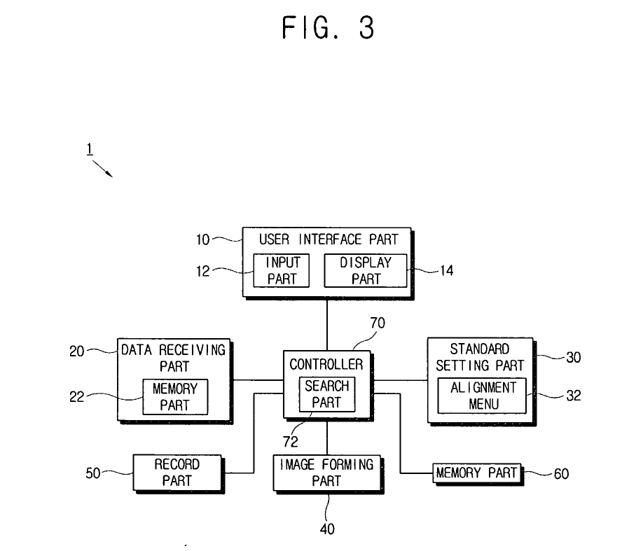

As shown in FIG. 3, an image forming apparatus 1 according to aspects of the present invention includes a user interface part 10, and a data receiving part 20 to receive printing files (print jobs or print files). A standard setting part 30 selects an alignment standard (alignment or order setting) to align (arrange, organize, and/or order) the printing files. A controller 70 aligns, arranges, organizes, and/or orders the printing files on the basis of the alignment standard set by the standard setting part 30 and displays the aligned printing files on the user interface part 10.

The image forming apparatus 1 has an image forming part 40 and a record part 50. The image forming part 40 prints one or more of the printing files on a medium, such as printing paper. The image forming part 40 may comprise a thermal transfer head, an electrophtographic developing device, an inkjet head, or the like. While not required, it is understood that ones of the shown elements can be combined, and that the apparatus 1 can have additional functionalities including faxing, copying, etc.

The record part 50 records a printing time information and a printing frequency information of the printing files printed once the image forming apparatus 40 prints the printing files. Accordingly, when a printing time order or a printing frequency order is selected in the alignment standard, the controller 70 can search the printing time information or the printing frequency information recorded by the record part 50 on receiving the printing file and align the printing file in the order according to a printing time or a printing frequency on the basis of the searched result.

The user interface part 10 includes an input part 12 and a display part 14. An input signal is selectively inputted by a user through the input part 12. A displayed predetermined information is perceived by a user using the display part 14. The input part 12 may comprise a keyboard, a keypad, a touch screen display, a pointing unit, biometric input, and/or other known input means. The display part 14 may comprise a liquid crystal display, a plasma display, or other known display or indicator units. The user interface part 10 may be provided as an operation panel arranged on the external side of the image forming apparatus 1, or a touch screen. Accordingly, in various aspects, the input part 12 and the display part 14 may be combined or separated. Moreover, it is understood that an input signal can be received from a host computer.

The data receiving part 20 may receive a printing file from an external apparatus (such as a computer, a memory, or a camera) or may receive the printing file generated by the image forming apparatus 1 (such as through a scanner). The data receiving part 20 may be provided with a memory part 22 storing the received or generated printing file. The controller 70 directly aligns the printing file which the data receiving part 20 receives through the standard setting part 30, or stores the printing file on the memory part 22 and then loads to align the printing file as necessary. The data receiving part 20 may receive the printing file from a portable memory unit such as a USB memory, a PC, a laptop computer, or a host capable of processing information. The printing file can be of an image file, a text file and other information files capable of being printed. In various aspects, the data receiving part 20 may receive the printing file over a network, such as a public network like the internet, a private network like an intranet, or a virtual private network, for example. Accordingly, in various aspects, the image forming apparatus may be addressed by IPv4 or IPv6 address scheme.

The standard setting part 30 sets up the alignment standard to align the printing file received by the data receiving part 20. The standard setting part 30 comprises an alignment menu 32 having a plurality of alignment standards (or alignment settings) capable of being selectively inputted (or selected) through the user interface part 10. The standard setting part 30 generates the alignment menu 32 for display. The controller 70 displays the alignment menu 32 on the user interface part 10, especially the display part 14. When a user selects and inputs a desired alignment standard in the alignment menu 32, the standard setting part 30 sets up the selected alignment standard on the basis of the input selection.

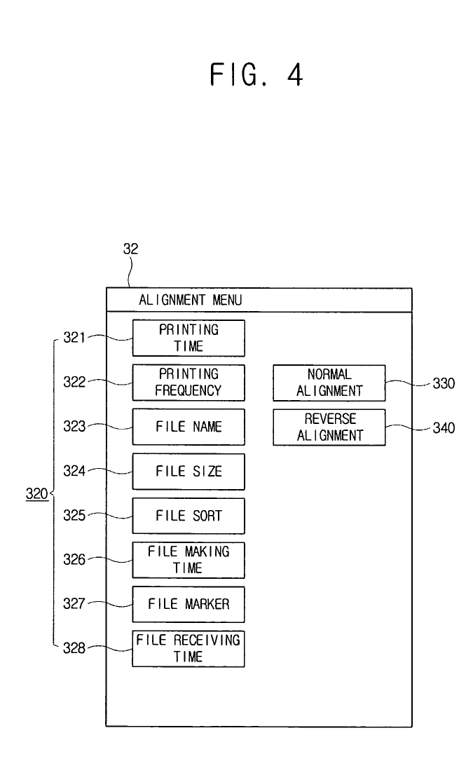

As shown in FIG. 4, the alignment menu 32 comprises a plurality of alignment standards (or settings) 320, a normal alignment 330 and a reverse alignment 340. The plurality of alignment standards (or alignment settings) include a printing time 321, which refers to an alignment standard to align the printing file printed by the image forming part 40 or the image forming apparatus 1 in the order of printing times (time stamp when printed). A printing frequency 322 refers to an alignment standard to align the printing file printed by the image forming part 40 or the image forming apparatus 1 in the order of printing frequencies (number of copies printed). The file name 323, a file size 324, a file sort (or type) 325, a file generated time 326 and a file maker (file generator or sender) 327 refer to alignment standards to align printing files on the basis of a file name, a file size, a file sort (or type), a file generated time, and a file maker's name (or a file generator's or sender's name), respectively. A receiving time 328 refers to an alignment standard to align printing files on the basis of the time when the data receiving part 20 receives the printing files.

The normal alignment 330 and the reverse alignment 340 are auxiliary alignment standards to align numbers or letters (alignment information) of the printing files in an alignment corresponding to the selected alignment standard 320, but in ascending or descending order. In various aspects, the normal alignment 330 and the reverse alignment 340 may be selected in addition to any one or more of the plurality of the alignment standards 320. In other aspects, the normal or reverse alignments may be performed automatically or as a default.

In various aspects, for example, when a user selects the printing frequency 322 and the normal alignment 330, the alignment standard (alignment setting) is set so that the printing files can be aligned from the fewest frequencies of printing the printing files to the most frequencies of printing the printing files. Accordingly, the printing file without any printing frequency (e.g., not yet or not to be printed) can be displayed on the uppermost position of the display part 14. In another example, when a user selects the printing time standard 321 and the reverse alignment 330, the alignment standard is set so that the printing files can be aligned from the most recently printed file to the least recently printed file in descending order. Accordingly, the printing files printed most recently by the image forming part 40 or the image forming apparatus 1 can be displayed on the uppermost position of the display part 14.

In various aspects, a user can simply search and select the least frequently printed file, the most frequently printed file, the least recently printed file, the most recently printed file, and the like among the plurality of printing files by a combined selection of one or more of the alignment standards 320 in conjunction with the normal alignment 330, or the reverse alignment 340, for ease of search and selection.

The standard setting part 30 can serially select a plurality of alignment standards through the user interface part 10. Accordingly, the controller 70 can first align the printing files according to the first selected alignment standard, and then align the printing files within the first aligned order according to the second selected alignment standard, and so on. Accordingly, the printing files having the same alignment rank (e.g., having the same number and/or letter value) in the first selected alignment standard can be aligned by the secondly selected alignment standard, and so on, to be differentiated. Therefore, the standard setting part 30 may select three or more of the alignment standards 320. Accordingly, various combinations of the alignment standards 320 may be selected based on the user's preference and accorded a hierarchy depending of a selection sequence.

The alignment menu of FIG. 4 is only an example, and does not limit the aspects of the present invention thereto. Accordingly, the standard setting part 30 can generate alignment standards not shown in FIG. 4 for the alignment menu 32. Additionally, the alignment menu 32 may be provided with a printing file order especially marked by a user and other alignment standards, such as special icons or indicia for book marking, etc. Also, the standard setting part 30 may set the alignment standard 320 not only on the basis of a user's selective input through the user interface part 10 but also on the basis of a selective input by a cable or a radio communication through the host, or on the basis of a process pre-programmed or default alignment standard. In various aspects, the alignment standard 320 may be pre-programmed with a default setting, or the pre-programmed alignment standard or default setting may be set or reset by the user as desired. Further, the alignment standard 320 can include a keyword search by which a string of letters used in a file name or user name are input and the alignment is based on a degree of match.

The controller 70 aligns the printing files on the basis of the alignment standard set by the alignment setting part 30, displays the printing files on the display part 14 in the selected aligned order, and readies the printing files in the aligned order for selection by a user. When the user selects a desired printing file from one of the aligned files through the input part 12, the controller 70 enables the image forming part 40 to print the selected printing file on a medium, such as the printing paper. The memory part 60 stores various information for the printing files. The memory part 60 may temporarily store the printing files or store information necessary for controlling of the controller 70. The controller 70 may load or record necessary information from the memory part 60.

Also, during operation, the controller 70 searches for information corresponding to the set alignment standard 320. The controller 70 searches for the relevant information from the printing files and uses the found information to align the printing files on the basis of the searched result. The controller 70 includes a search part 72 to search information corresponding to the selected alignment standard from within the printing files. For example, when the standard setting part 30 sets the file name 323 as an alignment standard, the search part 72 can search the file names of the printing files and the controller 70 can align the printing files in the order of the file names on the basis of the file name search result.

The controller 70 can enable the record part 50 to record and store the printing time information (the time when the printing files were printed) or the printing frequency information (the number of times the printing files were printed) of the file printed by the image forming part 40. The information may be recorded and stored in the memory part 60 instead of the information being stored on the corresponding printing file. When the standard setting part 30 sets the printing time 321 or the printing frequency 322 as the alignment standard, the controller 70 can search the printing time information or the printing frequency information of the respective printing files stored on the memory part 60 to align the printing files on the basis of the searched result.

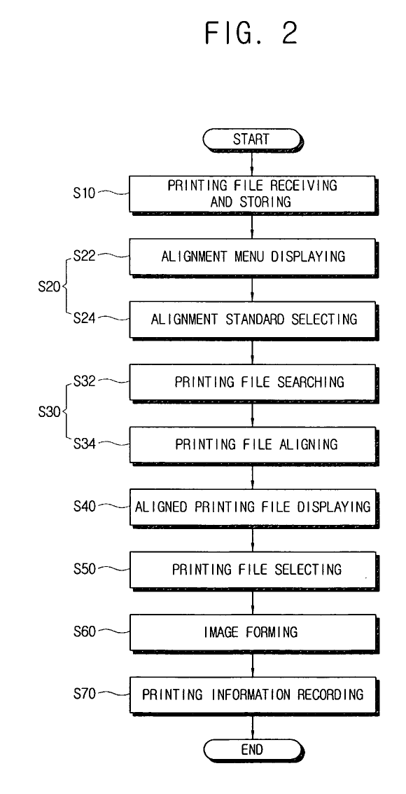

Hereinafter, the printing file processing method of the image forming apparatus according to an aspect of the present invention will be described in reference to FIGS. 2 to 4. As shown, firstly, the data receiving part 20 receives a printing file from, for example an external apparatus, to store the file in the memory part 22 (operation S10). Alternatively, the operation where the received printing file is stored on the memory part 22 may be omitted, or be replaced by an operation to directly print the file, or may even be replaced by an operation to generate the printing file. Next, one or more alignment standards are selected (operation S20). The alignment standard selecting operation has an operation S22 displaying the alignment menu 32 having a plurality of alignment standards 320 and an operation S24 selecting the one or more alignment standards from the alignment menu 32.

At the alignment standard selecting operation S24, a user can select at least one desired alignment standard through the user interface part 10. Accordingly, in the alignment standard selecting operation S24, a plurality of alignment standards or settings can be orderly or serially selected.

After the at least one alignment standard is selected, the controller 70 aligns the printing files on the basis of the at least one alignment standard (operation S30). The search part 72 searches the printing files (operation S32) and the controller 70 aligns the printing files on the basis of the searched result (operation S34). When a plurality of alignment standards are orderly selected in the alignment standard selecting operation S20, the printing files are first aligned according to the alignment standard first selected in the alignment operation S30, and then, the printing files are aligned within the aligned order according to the second selected alignment standard.

The controller 70 displays the printing files in the user interface part 10 in the aligned order (operation S40), and based on a user selection of a desired printing file (operation S50), prints the selected printing file (operation S60). Next, the printing time and the printing frequency are recorded on the printing file printed by the image forming part 40 or recorded in the record part 50 or the memory part 60 (operation S70). Here, the printing time or the printing frequency recording operation S70 may be omitted as necessary or desired. In such a case, the printing time 321 or the printing frequency 322 can be omitted in the alignment menu 32, or alternatively, be overridden or disabled.

In another aspect of the present invention, after the operation S40 displaying the aligned printing file, the image forming part 40 may print all the printing files in the aligned order without the operation S50 where a user selects a specific printing file.

In various aspects, by ordering or aligning a plurality of the printing files according to a first ordering instruction or alignment standard, a first level grouping of the plurality of the files is obtained. The first level grouping contains one or more groupings of the plurality of the files. Afterwards, the one or more groupings of the first level grouping is further ordered or aligned according to a second ordering instruction or alignment standard to obtain one or more corresponding second level groupings of each of the one or more groupings of the first level grouping. The one or more of the plurality of files in the one or more groupings of the first level grouping contain at least one characteristic in common, and the one or more of the plurality of files in the one or more groupings of the second level grouping contain at least two characteristics in common.

While not required in all aspects, elements of the method can be implemented as software and/or firmware for use with one or more processors and/or computers. Moreover a processor and/or computer readable medium maybe encoded with computer and/or processor-executable instructions to perform the method.

The image forming apparatus according to aspects of the present invention may comprise a thermal transfer printer that heats ink of an ink ribbon to transfer the ink onto a medium, such as a printing paper, an electrophotographic image forming apparatus using a potential difference of an electrostatic latent image formed on a photosensitive body, an inkjet printer that jets ink onto a medium, such as a printing paper, or other known image forming apparatuses. The image forming apparatus according to aspects of the present invention can be a portable device, and can impart images on media other than paper.

Although a few aspects of the present invention have been shown and described, it would be appreciated by those skilled in the art that changes may be made in the aspects without departing from the principles and spirit of the invention, the scope of which is defined in the claims and their equivalents.

What is claimed is:

1. A printing file processing method of an image forming apparatus which prints images on media, comprising:
receiving printing files;
displaying an alignment menu comprising a plurality of alignment standards to align the received printing files;
selecting one or more of the alignment standards in the displayed alignment menu;
aligning the received printing files on the basis of the selected alignment standards; and
displaying at the image forming apparatus the received printing files in the aligned order of the aligning operation.

2. The printing file processing method of an image forming apparatus according to claim 1, wherein the plurality of the alignment standards comprises a printing time order and/or a printing frequency order.

3. The printing file processing method of an image forming apparatus according to claim 1, wherein the plurality of the alignment standards comprises a file name order, a file size order, a file sort order, a file generated time order, a file maker order, a file receiving time order of the received printing files, or any combinations thereof.

4. The printing file processing method of an image forming apparatus according to claim 1, wherein the selecting of the one or more of the alignment standards includes serially selecting the one or more of the alignment standards, and
the aligning of the printing files includes aligning the printing files according to a first selected alignment standard, and then aligning the printing files within the first aligned order according to a next selected alignment standard.

5. The printing file processing method of an image forming apparatus according to claim 1, wherein the aligning of the printing files includes searching information corresponding to the selected alignment standard in the printing files and aligning the printing files on the basis of the searched result.

6. The printing file processing method of an image forming apparatus according to claim 1, further comprising:
selecting at least one of the displayed printing files after the displaying of the printing file, and
printing the selected at least one printing file.

7. The printing file processing method of an image forming apparatus according to claim 6, further comprising:
recording a printing time information and/or a printing frequency information of the selected at least one printing file.

8. The printing file processing method of an image forming apparatus according to claim 1, further comprising:
printing the printing files in the aligned order after the displaying of the printing file, and
recording a printing time information and/or a printing frequency information of the printed printing files.

9. An image forming apparatus, comprising:
a user interface part;
a data receiving part to receive printing files;
a standard setting part comprising an alignment menu for aligning the printing files and having a plurality of alignment standards capable of being selectively inputted through the user interface part; a controller to align the printing files on the basis of one or more of the plurality of alignment standards selected in the standard setting part, and to display the printing files on the user interface part in the aligned order; and
an image forming part to print the aligned printing files, wherein the controller enables the image forming part to print the aligned printing files selectively inputted through the user interface part.

10. The image forming apparatus according to claim 9, wherein the plurality of alignment standards comprises a printing time order and/or a printing frequency order.

11. The image forming apparatus according to claim 9, wherein the plurality of alignment standards comprises a file name order, a file size order, a file sort order, a file generated time order, a file maker order, a file receiving time order, or any combinations thereof, of the printing files.

12. The image forming apparatus according to claim 9, wherein the standard setting part can serially select one or more of the plurality of alignment standards through the user interface part, and the controller aligns the printing files according to a first selected alignment standard, and then aligns the printing files within the first aligned order according to the next selected alignment standard.

13. The image forming apparatus according to claim 9, wherein the controller searches information corresponding to the selected alignment standard in the printing files to align the printing files on the basis of the searched result.

14. The image forming apparatus according to claim 9, further comprising a record part to record at least one of a printing time information and the printing frequency information of the printing files printed by the image forming part.

15. A computer readable medium recorded with a program for a computer included in an image forming apparatus to execute a file processing method of an image forming apparatus, wherein the computer executes the method of claim 1.

16. A file processing method of an image forming apparatus, the image forming apparatus having received a plurality of files and containing one or more ordering instructions selectable by a user to order the plurality of the files according to desired characteristics of the files, the method comprising:
ordering a plurality of the files according to a first ordering instruction to obtain a first level grouping of the plurality of the files, wherein the first level grouping contains one or more groupings of the plurality of the files; and
ordering the one or more groupings of the first level grouping according to a second ordering instruction to obtain one or more corresponding second level groupings of each of the one or more groupings of the first level grouping.

17. The file processing method of an image forming apparatus according to claim 16, wherein the one or more of the plurality of files in the one or more groupings of the first level grouping contain at least one characteristic in common, and the one or more of the plurality of files in the one or more groupings of the second level grouping contain at least two characteristics in common.

18. The file processing method of an image forming apparatus according to claim 16, wherein the desired characteristics are selectable between a file name, a file size, a file type, a file generated time, a file maker, and a file receiving time, of the plurality of the files.

19. The file processing method of an image forming apparatus according to claim 16, wherein the desired characteristics are at least one of a printing time and/or a printing frequency.

20. The file processing method of an image forming apparatus according to claim 16, wherein the ordering of the plurality of the files and the ordering of the one or more groupings order the plurality of the files in ascending or descending order.

21. The file processing method of an image forming apparatus according to claim 16, further comprising:
receiving the plurality of the files;
displaying an ordering menu comprising one or more of the ordering instructions;
selecting one or more of the ordering instructions in the ordering menu; and
displaying the ordered plurality of the files.

22. A computer readable medium recorded with a program for a computer included in an image forming apparatus to execute a file processing method of an image forming apparatus, wherein the computer executes the method of claim 16.

23. An image forming apparatus, comprising:
a user interface part;
a data receiving part to receive a plurality of files;
a standard setting part containing one or more ordering instructions selectable by a user to order the plurality of the files according to desired characteristics of the files;
a controller to order a plurality of the files according to a first ordering instruction to obtain a first level grouping of the plurality of the files, wherein the first level grouping contains one or more groupings of the plurality of the files, and to order the one or more groupings of the first level grouping according to a second ordering instruction to obtain one or more corresponding second level groupings of each of the one or more groupings of the first level grouping; and
an image forming part to print the ordered files, wherein the controller enables the image forming part to print the ordered files.

24. The image forming apparatus according to claim 23, wherein the one or more of the plurality of files in the one or more groupings of the first level grouping contain at least one characteristic in common, and the one or more of the plurality of files in the one or more groupings of the second level grouping contain at least two characteristics in common.

25. The image forming apparatus according to claim 23, wherein the desired characteristics are selectable between a file name, a file size, a file type, a file generated time, a file maker, and a file receiving time, of the plurality of the files.

26. The image forming apparatus according to claim 23, wherein the desired characteristics are at least one of a printing time and/or a printing frequency.

27. The image forming apparatus according to claim 23, wherein the ordering of the plurality of the files and the ordering of the one or more groupings order the plurality of the files in ascending or descending order.
